(19) United States
(12) Patent Application Publication
(10) Pub. No.: US 2023/0152791 A1
(43) Pub. Date: May 18, 2023

(54) MULTI-MODALITY DATA ANALYSIS ENGINE FOR DEFECT DETECTION

(71) Applicant: NEC Laboratories America, Inc., Princeton, NJ (US)

(72) Inventors: LuAn Tang, Pennington, NJ (US); Yuncong Chen, Plainsboro, NJ (US); Wei Cheng, Princeton Junction, NJ (US); Haifeng Chen, West Windsor, NJ (US); Zhengzhang Chen, Princeton Junction, NJ (US); Yuji Kobayashi, Tokyo (JP)

(21) Appl. No.: 17/984,413

(22) Filed: Nov. 10, 2022

Related U.S. Application Data
(60) Provisional application No. 63/278,568, filed on Nov. 12, 2021.

(51) Int. Cl. G05B 23/02; G06N 20/00

(52) U.S. Cl. CPC G05B 23/0221; G06N 20/00; G05B 23/0235; G05B 23/0237

(57) ABSTRACT

Systems and methods for defect detection for vehicle operations, including collecting a multiple modality input data stream from a plurality of different types of vehicle sensors, extracting one or more features from the input data stream using a grid-based feature extractor, and retrieving spatial attributes of objects positioned in any of a plurality of cells of the grid-based feature extractor. One or more anomalies are detected based on residual scores generated by each of cross attention-based anomaly detection and time-series-based anomaly detection. One or more defects are identified based on a generated overall defect score determined by integrating the residual scores for the cross attention-based anomaly detection and the time-series based anomaly detection being above a predetermined defect score threshold. Operation of the vehicle is controlled based on the one or more defects identified.

### RELATED APPLICATION INFORMATION

This application claims priority to U.S. Provisional App. No. 63/278,568, filed on Nov. 12, 2021, incorporated herein by reference in its entirety.

### BACKGROUND

### Technical Field

The present invention relates to a multi-modality data analysis engine for vehicle sensors, and more particularly to improved accuracy of real-time defect detection for autonomous, semi-autonomous, and/or notification-assisted operation of a vehicle based on an analysis a plurality of different types of data collected from vehicle sensors during operation of a vehicle.

### Description of the Related Art

Conventional autonomous, semi-autonomous, and/or notification-assisted vehicles utilize a plurality of cameras placed on different areas of a vehicle (e.g., front, rear, left, right, etc.) to attempt to collect relevant data for autonomous driving by constructing a full, 360-degree view of the surrounding area during operation of the vehicle. While conventional, camera based autonomous driving systems provide accurate depictions of the view captured by each of the cameras, it is often difficult or not possible to determine relevant features such as a distance of a particular object when using such systems. Further, such camera based autonomous driving systems generally function poorly in low-visibility conditions (e.g., night, fog, rain, snow, etc.), which can result in low accuracy of data analysis and/or poor performance of vehicle operation tasks (e.g., acceleration, braking, notification of obstacles, etc.).

### SUMMARY

According to an aspect of the present invention, a method is provided for defect detection for vehicle operations, including collecting a multiple modality input data stream from a plurality of different types of vehicle sensors, extracting one or more features from the input data stream using a grid-based feature extractor, and retrieving spatial attributes of objects positioned in any of a plurality of cells of the grid-based feature extractor. One or more anomalies are detected based on residual scores generated by each of cross attention-based anomaly detection and time-series-based anomaly detection. One or more defects are identified based on a generated overall defect score determined by integrating the residual scores for the cross attention-based anomaly detection and the time-series based anomaly detection being above a predetermined defect score threshold. Operation of the vehicle is controlled based on the one or more defects identified.

According to another aspect of the present invention, a system is provided for defect detection for vehicle operations, including a processor device configured for collecting a multiple modality input data stream from a plurality of different types of vehicle sensors, extracting one or more features from the input data stream using a grid-based feature extractor, and retrieving spatial attributes of objects positioned in any of a plurality of cells of the grid-based feature extractor. One or more anomalies are detected based on residual scores generated by each of cross attention-based anomaly detection and time-series-based anomaly detection. One or more defects are identified based on a generated overall defect score determined by integrating the residual scores for the cross attention-based anomaly detection and the time-series based anomaly detection being above a predetermined defect score threshold. Operation of the vehicle is controlled based on the one or more defects identified.

According to another aspect of the present invention, a non-transitory computer readable storage medium including contents that are configured to cause a computer to perform a method for defect detection for vehicle operations, including collecting a multiple modality input data stream from a plurality of different types of vehicle sensors, extracting one or more features from the input data stream using a grid-based feature extractor, and retrieving spatial attributes of objects positioned in any of a plurality of cells of the grid-based feature extractor. One or more anomalies are detected based on residual scores generated by each of cross attention-based anomaly detection and time-series-based anomaly detection. One or more defects are identified based on a generated overall defect score determined by integrating the residual scores for the cross attention-based anomaly detection and the time-series based anomaly detection being above a predetermined defect score threshold. Operation of the vehicle is controlled based on the one or more defects identified.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a high-level view of a system and method for defect detection based on an analysis of a plurality of different types of data from vehicle sensors for autonomous, semi-autonomous, and/or notification-assisted operation of a vehicle, in accordance with embodiments of the present invention;

FIG. 3 is a diagram illustratively depicting a system and method for cross-attention based defect detection based on an analysis of a plurality of different types of data from vehicle sensors for autonomous, semi-autonomous, and/or notification-assisted operation of a vehicle, in accordance with embodiments of the present invention;

FIG. 4 is a block/flow diagram illustratively depicting a high-level method for cross-attention based defect detection based on an analysis of a plurality of different types of data from vehicle sensors for autonomous, semi-autonomous, and/or notification-assisted operation of a vehicle, in accordance with embodiments of the present invention;

FIG. 5 is a diagram illustratively depicting a method for grid-based feature retrieval to extract features from multi-dimensional sensor data for autonomous, semi-autonomous, and/or notification-assisted operation of a vehicle, in accordance with embodiments of the present invention;

FIG. 6 is a diagram illustratively depicting a high-level view of a system and method for cross-attention based defect detection based on an analysis of a plurality of different types of data from vehicle sensors for autonomous, semi-autonomous, and/or notification-assisted operation of a vehicle, in accordance with embodiments of the present invention;

FIG. 7 is a diagram illustratively depicting a system for cross-attention based defect detection based on an analysis of a plurality of different types of data from vehicle sensors for autonomous, semi-autonomous, and/or notification-assisted operation of a vehicle, in accordance with embodiments of the present invention;

FIG. 8 is a diagram illustratively depicting a system for anomaly detection based on an analysis of a plurality of different types of data from vehicle sensors for autonomous, semi-autonomous, and/or notification-assisted operation of a vehicle, in accordance with embodiments of the present invention;

FIG. 9 is a block/flow diagram illustratively depicting a method for cross-attention based defect detection based on an analysis of a plurality of different types of data from vehicle sensors for autonomous, semi-autonomous, and/or notification-assisted operation of a vehicle, in accordance with embodiments of the present invention;

FIG. 10 is an exemplary system illustratively depicting an exemplary vehicle utilizing cross-attention based defect detection based on an analysis of a plurality of different types of data from vehicle sensors for autonomous, semi-autonomous, and/or notification-assisted operation of a vehicle, in accordance with embodiments of the present invention; and

FIG. 11 is a diagram illustratively depicting a high-level system for cross-attention based defect detection based on an analysis of a plurality of different types of data from vehicle sensors for autonomous, semi-autonomous, and/or notification-assisted operation of a vehicle, in accordance with embodiments of the present invention.

### DETAILED DESCRIPTION OF PREFERRED EMBODIMENTS

In accordance with embodiments of the present invention, systems and methods are provided for autonomous, semi-autonomous, and/or notification-assisted operation of a vehicle, with improved accuracy of real-time defect detection during operation of a vehicle based on an analysis a plurality of different types of data collected from vehicle sensors.

In various embodiments, a plurality of different types of sensors (e.g., cameras, Radar, proximity sensors, LIDAR, GPS, etc.) can be installed and utilized on a vehicle (e.g., automobile, aircraft, drone, boat, rocket ship, etc.) for autonomous, semi-autonomous, and/or notification-assisted operation of a vehicle, in accordance with aspects of the present invention. For ease of illustration, such vehicles capable of autonomous, semi-autonomous, and/or notification-assisted operation, in accordance with embodiments of the present invention are referred to as “autonomous vehicles” herein below.

In various embodiments, an autonomous vehicle with a plurality of different types of sensors can collect sensor data in multiple formats (e.g., “multi-modality”), and can integrate multiple data modalities (e.g., different types of data from different types of sensors) from each of the different sensors for cross-attention based defect detection during operation of a vehicle. For many data analysis tasks (e.g., failure detection, auto-driving assistant system (ADAS) defect detection, ADAS video search, etc.), the accuracy is generally low in conventional systems, as conventional systems generally rely only on a single data modality.

The utilization of multi-modality data for controlling operation of an autonomous vehicle, in accordance with embodiments of the present invention, can increase accuracy of real-time data analysis tasks (e.g., data analysis of vehicle and/or external conditions for autonomous control of various functions of an autonomous vehicle). Further, such utilization and analysis of multi-modality data provides increased accuracy and confidence for any of a plurality of autonomous tasks during operation of an autonomous vehicle, in accordance with aspects of the present invention.

In various embodiments, as will be described in further detail herein below, the present invention can be utilized to solve a variety of problems that conventional autonomous driving systems fail to adequately address. For example, when utilizing multiple vehicle sensors to collect multi-modality data, raw sensor data can be dynamic and noisy, which can result in lowered accuracy for data analysis tasks. The present invention can utilize the multi-modality sensor data as input for cross-attention based defect detection during operation of a vehicle, in accordance with aspects of the present invention.

Further, it can be difficult to determine an analysis result by utilizing only a single modality, as in conventional systems, at least in part because a single modality includes limited scope and cannot provide sufficient data for accurate analysis and judgments for autonomous vehicle control tasks. The present invention can provide increased accuracy of such data analysis for anomaly and defect detection at least in part by utilizing data from multiple modalities from a plurality of different types of sensors for a complete and accurate view of the vehicle and the surrounding environment, in accordance with aspects of the present invention.

In various embodiments, multi-modality data can be collected from different sources and sensors, and each can collect data and describe different aspects of the monitored system(s). It can be important for calculation speed and/or accuracy to apply the influences of one modality to others when conducting anomaly detection tasks. The present invention can utilize a cross-attention based anomaly detection engine to find anomalies from multi-modality data, and further utilize the application of the anomaly detection engine for defect analysis in Autonomic Driving Assistant System (ADAS) for any of a plurality of types of vehicles, in accordance with aspects of the present invention.

In some embodiments, input of the ADAS can be, for example, a set of multi-modal sequences from different sensors installed on a vehicle, and the data acquired can include system data and/or environmental data. System data collected using the sensors can include data regarding a plurality of types of system status (e.g., speed, acceleration, turning angle, braking performance, transmission performance, etc.) of a vehicle (e.g., electric ego car, airplane, boat, location, etc.), which can be collected from one or more sensors (e.g., CANBus sensor, GPS sensor, etc.) before or during operation of a vehicle.

Environmental data collected using the sensors can include data which can describe a surrounding environment (e.g., object detection, lane detection, road hazard detection, etc.) of a vehicle, and can be collected from one or more sensors (e.g., LIDAR sensor, camera, proximity sensor, temperature sensor, radar, etc.). In some embodiments, such data can be collected in irregular time series format (and in other embodiments can be collected in regular time series with fixed dimensions), and the data collected in irregular time series format can be transformed and transferred into a regular time series format for further processing, in accordance with aspects of the present invention. It is noted that a vehicle's LIDAR sensor data is very dynamic and noisy, and the present invention can include a specialized processing tool for retrieval of determined useful features from the multi-modality data and utilize a differential based system to effectively detect ADAS defects before and/or during vehicle operation, in accordance with aspects of the present invention.

In some embodiments, an output of an ADAS defect task (which can be determined based on the collected system and/or environmental data) can be a defect score along the time (e.g., in time series format), and if the score is larger than a predefined threshold, a defect can be reported to an end user and/or a controller can automatically adjust navigation (or other vehicle tasks) to account for the defect, in accordance with aspects of the present invention. A defect can be a wrong action of the car according to the environment (e.g., not avoiding an obstacle, changing lanes to avoid an obstacle when no obstacle exists, driving off the road, etc.), and conventional systems which utilize only a pattern/value change in a single modality of the data often will not identify defects at least due to the limited collection and/or use of multi-modal data during vehicle operation. For example, a car should reduce speed when entering a branching point, so if the car indeed did reduce speed, it should not be identified as a defect, even though the value of the speed changes. However, if the car does not execute a braking action upon entering a branching point, and thus the speed value remains the same, it should be identified as a defect, reported to the user, and or initiate corrective action during vehicle operation, in accordance with aspects of the present invention.

In various embodiments, the present system and method can integrate the data from multiple modalities and make a judgement based on the changes of multiple modalities for defect detection and/or autonomous vehicle navigation. The existing state-of-art anomaly detection algorithms can function only on a single or a small number of dimensions, and thus cannot detect such defects effectively. Indeed, conventional systems can only detect the anomalies/outliers for one or few sensors, but cannot detect the defects (e.g., re-action errors) based on given environments.

In contrast, in various embodiments, the present invention can utilize a cross-attention based analysis engine for multi-modality data, and its applications on ADAS defect detection on vehicle data to achieve high accuracy and speed of identification of defects during vehicle operation. The attention can represent the measurement for the environment changes. The cross-attention based mechanism can apply the influences of environmental changes to the vehicle's (e.g., autonomous vehicle, ego car, etc.) system data, and can construct a model to record the normal re-actions of the vehicle in different environments. In some embodiments, in an online testing step, the defect detection engine can first determine a current environment of a vehicle (e.g., environment awareness) and then can select a corresponding model for defect detection on the system data, in accordance with aspects of the present invention.

In various embodiments, utilization of a cross-attention mechanism can execute environmental aware based anomaly/defect detection, which outperforms conventional systems and methods with regard to accuracy and speed of calculating and identifying defects at least in part because conventional anomaly detection systems can only function on one or very few environments. The present invention can account for and utilize multiple types of data from multiple dynamic environments, thus achieving comparatively higher accuracy in detection of complex defect patterns during vehicle operation, in accordance with aspects of the present invention.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

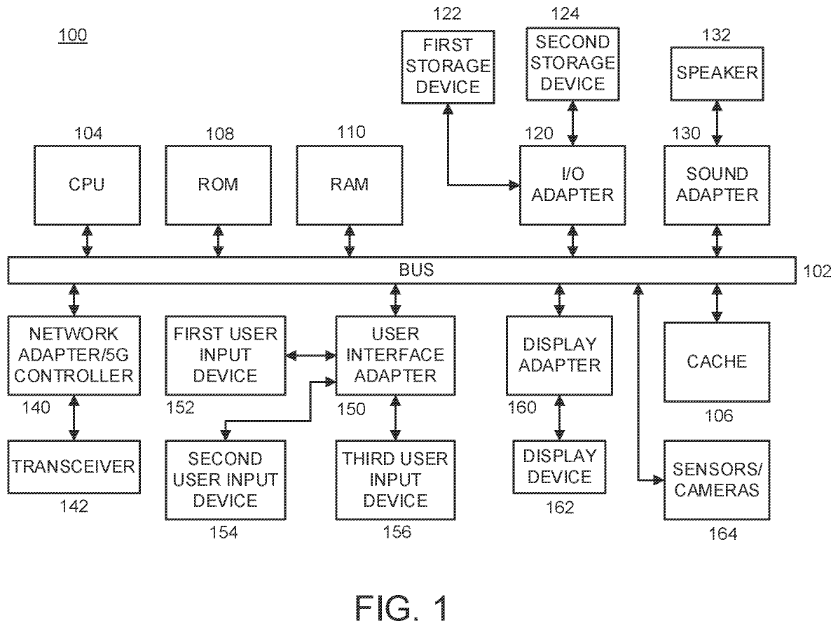

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. One or more sensors 164 (e.g., cameras, proximity sensors, LIDAR data, GPS data, time-series signal detectors, etc.) can be further coupled to system bus 102 by any appropriate connection system or method (e.g., Wi-Fi, wired, network adapter, etc.), in accordance with aspects of the present invention.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

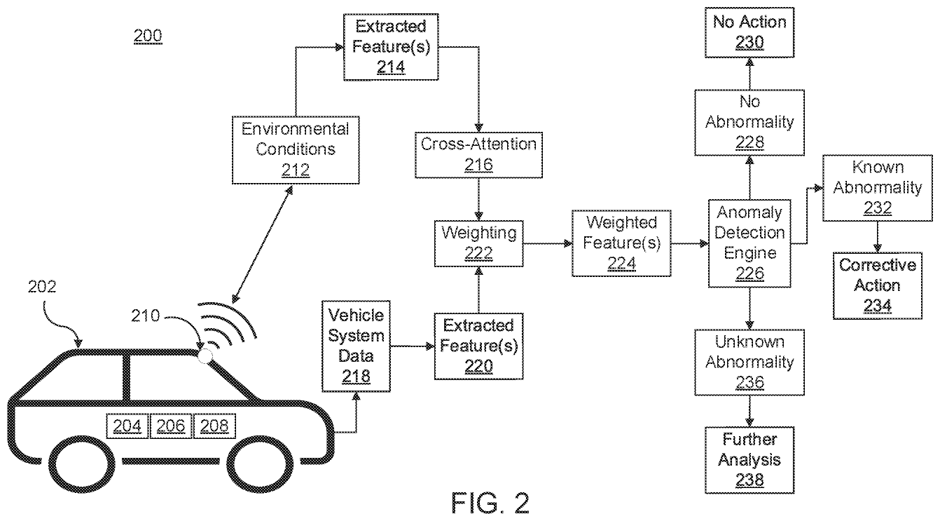

Moreover, it is to be appreciated that systems 200, 300, 600, 700, 800, 1000, and 1100, described below with respect to FIGS. 2, 3, 6, 7, 8, 10, and 11, respectively, are systems for implementing respective embodiments of the present invention. Part or all of processing system 100 may be implemented in one or more of the elements of systems 200, 300, 600, 700, 800, 1000, and 1100, in accordance with aspects of the present invention.

Further, it is to be appreciated that processing system 100 may perform at least part of the methods described herein including, for example, at least part of methods 200, 300, 400, 500, and 900, described below with respect to FIGS. 2, 3, 4, 5, and 9, respectively. Similarly, part or all of systems 200, 300, 600, 700, 800, 1000, and 1100 may be used to perform at least part of methods 200, 300, 400, 500, and 900 of FIGS. 2, 3, 4, 5, and 9, respectively, in accordance with aspects of the present invention.

As employed herein, the term “hardware processor subsystem”, “processor”, or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Referring now to FIG. 2, a diagram showing a high-level view of a system and method 200 for defect detection based on an analysis of a plurality of different types of data from vehicle sensors for autonomous, semi-autonomous, and/or notification-assisted operation of a vehicle, is illustratively depicted in accordance with embodiments of the present invention.

In an embodiment, a vehicle 202 (e.g., autonomous car, airplane, boat, etc.) can include one or more sensors 210 (e.g., LIDAR, GPS, radar, cameras, microphones, etc.) which can collect a plurality of different types of data for environmental conditions 212 during operation of the vehicle 202. The environmental conditions data can be stored in a computer-readable storage medium 204, can be analyzed (e.g., for anomalies and/or defects) using a processor device 206, and the vehicle 202 can be automatically controlled (e.g., accelerate, brake, turn, enable/disable lights, and/or perform any other vehicle functions) based on, for example, detected defects, using an automatic vehicle controller 208, in accordance with aspects of the present invention. Vehicle system data 218 (e.g., speed, acceleration, braking, etc.) can be collected using the processor device 206, and the system data 218 can be analyzed (e.g., for anomalies and/or defects) using a processor device 206, and the vehicle 202 can be automatically controlled (e.g., accelerate, brake, turn, enable/disable lights, and/or perform any other vehicle functions) based on, for example, detected defects, using an automatic vehicle controller 208, in accordance with aspects of the present invention.

In some embodiments, features can be extracted from the vehicle system data 218 in block 220, and features can be extracted from the environmental conditions data 212 in block 214. Attentions can be computed based on environments and cross-applied to system measures (e.g., system data 218) using cross attention in block 216. Weights can be determined and/or applied in block 222 to generate weighted features in block 224, in accordance with aspects of the present invention. An anomaly detection engine 226 can determine whether a received weighted feature 224 includes “no abnormality” 228, a “known abnormality” 232, and/or an “unknown abnormality” 236, and upon such a determination, can recommend and/or execute a corresponding command. In various embodiments, if no abnormality is identified in block 228, the controller 208 may take no action, if a known abnormality is identified in block 232, the controller 208 may make a corrective action (e.g., executing a lane change, braking, accelerating, etc.) in block 234, and if an unknown abnormality is identified in block 236, the controller 208 may instruct the processor device 206 to perform further analysis of the weighted features 224 before taking any action. In some embodiments, if an unknown abnormality is identified in block 236, the controller 208 may slow the vehicle to a gradual stop and pull over until the abnormality is identified, while in other embodiments, vehicle operation can proceed during the further analysis in block 238 upon a determination that the unknown abnormality 236 is not an immediate danger to the vehicle 202 or its occupants, in accordance with aspects of the present invention.

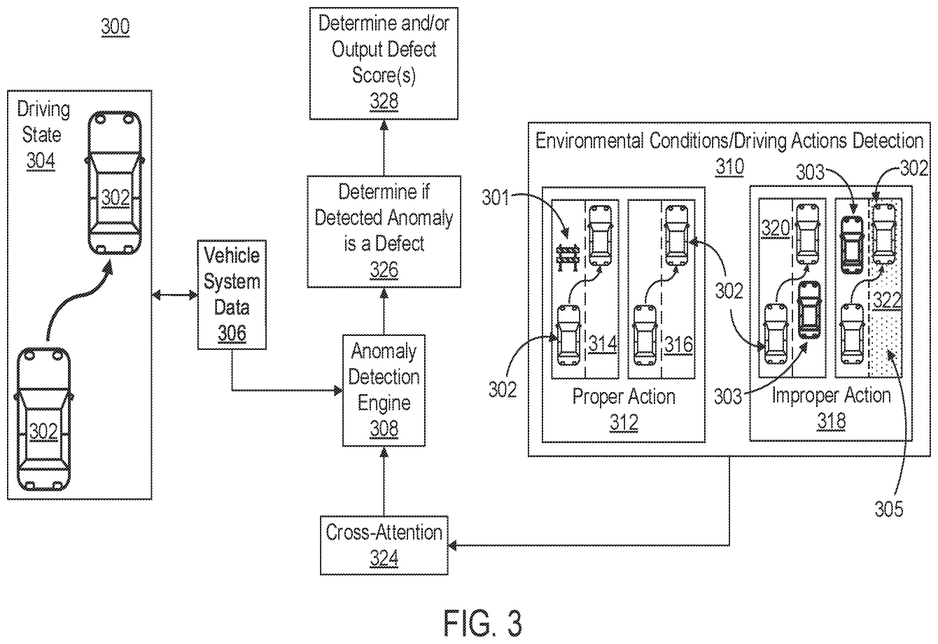

Referring now to FIG. 3, a diagram showing a high-level view of a system and method 300 for cross-attention based defect detection based on an analysis of a plurality of different types of data from vehicle sensors for autonomous, semi-autonomous, and/or notification-assisted operation of a vehicle, is illustratively depicted in accordance with embodiments of the present invention.

In one embodiment, a driving state 304 (e.g., change lane, braking, accelerating, etc.) can be identified for a vehicle 304 (e.g., autonomous vehicle), and vehicle system data 306 can be identified and collected in block 306 for use in detecting anomalies by an anomaly detection engine 308. Environmental conditions/Driving actions detection can be performed in block 310.

In block 312, proper actions for operation of the vehicle 302 can be identified and may include, for example, avoiding an obstacle 301 by conducting a lane change action in block 314 when there is an environment change (e.g., an obstacle 301 is detected in the way), and a lane change action not responsive to an obstacle but remaining on the roadway in a new lane in block 316. In block 318, improper actions (e.g., defects) for operation of the vehicle 302 can be identified and may include, for example, changing lanes in an improper situation, such as executing a lane change operation in block 320 when another vehicle 303 is already in the destination lane, or conducting a lane change action to a forbidden area (e.g., road shoulder, off the road, etc.) in a passing attempt in block 322, in accordance with aspects of the present invention. In this exemplary embodiment, for ease of illustration, a lane change driving action is shown in blocks 314, 316, 320, and 322, but is to be appreciated that any sort of driving action or environmental condition detection can be performed in accordance with various aspects of the present invention.

In some embodiments, environmental conditions/driving actions detection data from block 310 can be analyzed using cross attention in block 324 and vehicle system data 306 can be input into an anomaly detection engine 308 to detect one or more anomalies in the vehicle system data 306 and/or environmental conditions/driving actions detection data from block 310. It can be determined whether detected anomalies are defects in block 326, and a defect score can be determined and/or output in block 328 for use in any of a plurality of autonomous driving tasks, in accordance with aspects of the present invention.

It is to be appreciated that although the system and method 300 is described herein below as being directed to autonomous vehicle control, the present principles can be applied to other cyber physical systems (e.g., smart city (camera, video, temperature sensor, etc.), smart house, etc.), in accordance with aspects of the present invention.

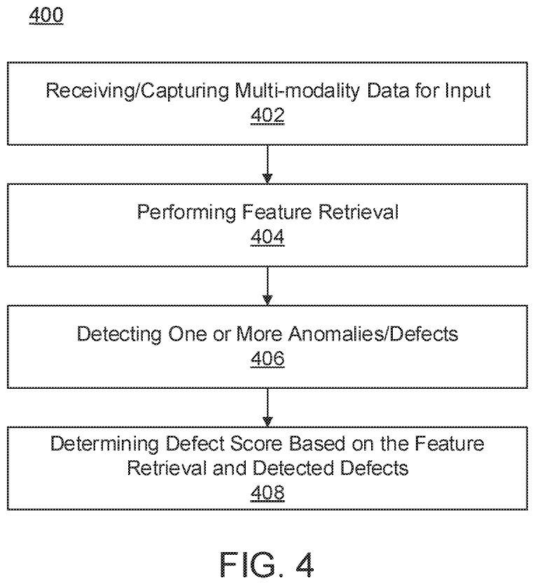

Referring now to FIG. 4, a block/flow diagram showing a high-level method 400 for cross-attention based defect detection based on an analysis of a plurality of different types of data from vehicle sensors for autonomous, semi-autonomous, and/or notification-assisted operation of a vehicle, is illustratively depicted in accordance with embodiments of the present invention.

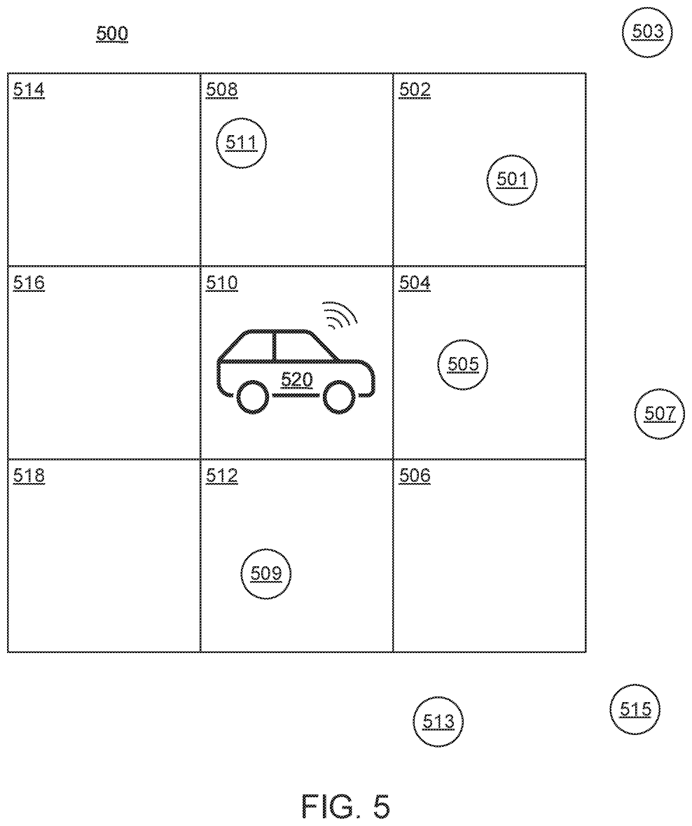

In accordance with various embodiments, multi-modality data (e.g., environmental and vehicle data of various types/formats) can be captured and/or received in block 402, and feature retrieval from the data can be executed in block 404. In block 406, one or more anomalies and/or defects can be identified in the vehicle system data and/or environmental conditions data, and a defect score can be generated in block 408, in accordance with aspects of the present invention, as will be described in further detail herein below with reference to FIGS. 5, 6, 7, and 8.

Referring now to FIG. 5, a diagram showing a method 500 for grid-based feature retrieval to extract features from multi-dimensional sensor data for autonomous, semi-autonomous, and/or notification-assisted operation of a vehicle, is illustratively depicted in accordance with embodiments of the present invention.

In some embodiments, an input data stream from one or more sensors (e.g., LIDAR sensors, video cameras, proximity sensors, infrared sensors, microphones, velocity sensors, etc.) disposed on a vehicle 520 can be monitored and data can be collected and/or received for extracting features from the sensor data using a grid-based feature retrieval method 500. For ease of illustration, the sensor data described herein below will be LIDAR sensor data, but it is to be appreciated that other sorts of sensor data can be utilized in accordance with various aspects of the present invention.

It is noted that a major sensor that vehicles can use to sense the surrounding environment is LIDAR sensors. Such a sensor can detect the surrounding objects and lanes by the reflection of laser radar signals. The LIDAR data format can be described as a sequence of detected objects, with the objects including object attributes such as, for example, the speed, size, acceleration, position, etc. of a vehicle 520. A problem with utilizing the LIDAR data for operation of a vehicle is that, the detected object in each timestamp is generally not fixed. For example, there may be 20 objects around a vehicle 520 at timestamp T1, and 30 objects around ego car at timestamp T2. The present invention can, as a first step, retrieve a fixed number of features from dynamic changing object detection data, in accordance with aspects of the present invention.

In some embodiments, a grid-based feature retrieval method 500 can be utilized for feature extraction by dividing a spatial area into a grid with 9 cells (502, 504, 506, 508, 510, 512, 514, 516, and 518), with a vehicle 520 in cell 510 (e.g., center cell). Thus, in this embodiment, there are 8 cells surrounding the vehicle 520. Each cell can have a pre-defined length and width, and only the detected objects located in the cells (e.g., 501, 505, 509, and 511) may be considered and analyzed while the detected objects located outside of the 9 cells (e.g., 503, 507, 513, and 515) may not be considered or analyzed for feature extraction, as such objects (e.g., 503, 507, 513, and 515) can be determined to be sufficiently distant from the vehicle 520, and thus can be ignored during grid-based retrieval, in accordance with aspects of the present invention

In some embodiments, for each cell (502, 504, 506, 508, 510, 512, 514, 516, and 518), spatial attributes of objects, and the objects can be retrieved, and can include, for example, an object number, a nearest object size, a nearest object distance, a nearest object speed, etc., such that no matter how many objects are detected and how the total number changes, there can always be a fixed number of features from the 9 cells, in accordance with aspects of the present invention.

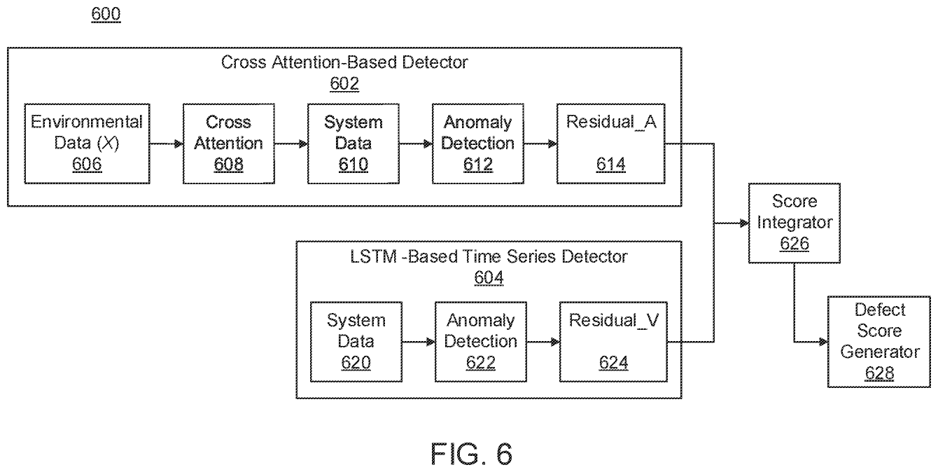

Referring now to FIG. 6, a diagram showing a system and method 600 for cross-attention based defect detection based on an analysis of a plurality of different types of data from vehicle sensors for autonomous, semi-autonomous, and/or notification-assisted operation of a vehicle, is illustratively depicted in accordance with embodiments of the present invention.

In various embodiments, two detectors can be utilized for anomaly and/or defect detection, in accordance with aspects of the present invention. One detector can be a cross-attention based detector 602, which can utilize both environment data 606 and system data 610 as input for executing cross-attention 608. One or more anomalies can be detected in block 613, and a residual score (Residual_A) can be determined and output in block 614, in accordance with aspects of the present invention. Another detector utilized can be a long short-term memory (LSTM) based time series detector 604, which in some embodiments can utilize only system data 620 as input for anomaly detection in block 622, and another residual score (Residual_V) can be determined and output in block 624.

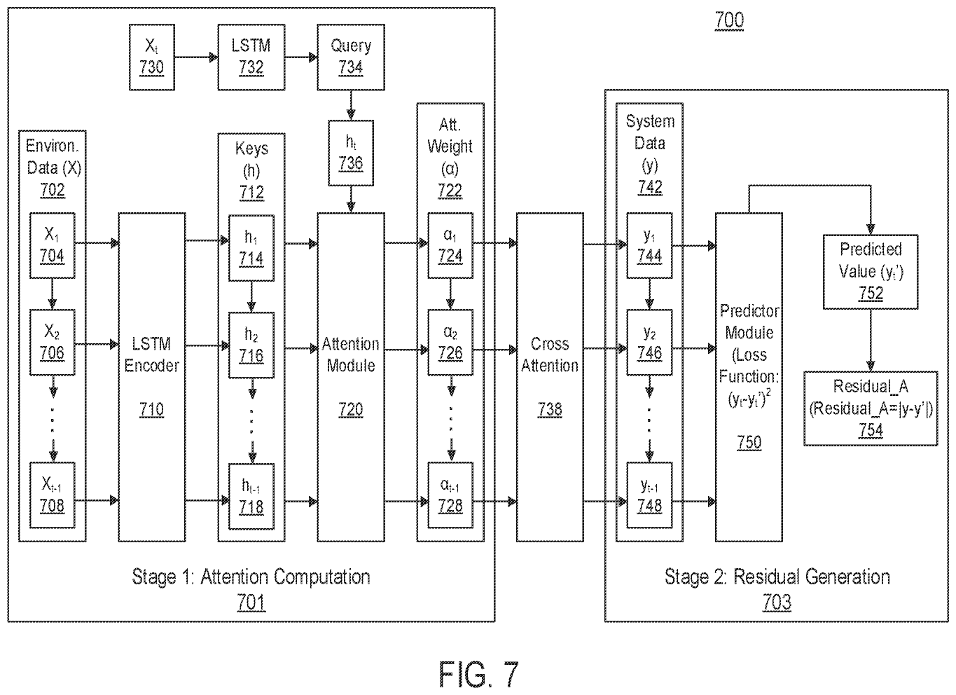

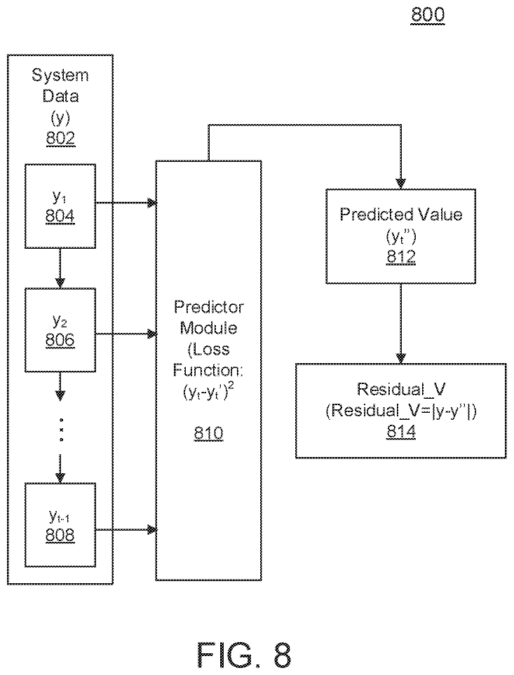

Note that, the residual scores (Residual_A 614 and Residual_V 624) can be the differences between a prediction and real value of system data 610, 620, and will be described in further detail herein below with reference to FIGS. 7 and 8. The cross attention-based detector 602 and the LSTM-based detector 604 can be trained by normal data to predict the values, and the differences of prediction and real values can be minimized during the training steps. In an online testing step, if any comparatively very big differences (e.g., high residual scores) are observed, it can indicate that there are different actions (e.g., anomalies) occurring, but such a detection of an anomaly does not necessarily mean a defect is present. In some embodiments, Residual_A 614 and Residual_V 624 can be input into a score integrator 626 and combined, and a defect score generator 628 can use the combined data from the score integrator 626 to determine whether a defect is present based on the defect score generated based on the comparison of both residuals in block 628, in accordance with aspects of the present invention.

In some embodiments, a score integrator 626 can compare residual scores (e.g., from block 754 of FIG. 7 and block 814 of FIG. 8), and analyze them to determine final defect scores in block 628. The final defect scores 628 can be computed as follows:
defect_score=max (0, residual_A-residual_V),
   in accordance with aspects of the present invention. If the score residual_A is smaller than residual_V, it can indicate that the changes of system data are adaptive to the environment changes, and thus, the system can be determined to have conducted appropriate re-actions to the environment changes, resulting in no finding of a defect. If the score residual_A is larger than residual_V, it can indicate that changes of system data (e.g., driving actions) have been determined to be not appropriate with regard to the environmental changes (e.g., obstacle in road, etc.), or even an opposite action to deemed appropriate actions to the environment changes, in can indicate that the system executed inappropriate re-actions to the environment changes, resulting in a finding of a defect, which can be reported to the user, in accordance with aspects of the present invention.

Referring now to FIG. 7, a diagram showing a system 700 for cross-attention based defect detection based on an analysis of a plurality of different types of data from vehicle sensors for autonomous, semi-autonomous, and/or notification-assisted operation of a vehicle, is illustratively depicted in accordance with embodiments of the present invention.

In one embodiment, the cross attention-based defect detection system 700 can include two main stages: an attention computation stage 701 and a residual generation stage 703, in accordance with aspects of the present invention. In the attention computation stage 701, environmental data (X) 702 can be collected and/or received as input over time (e.g., X₁ 704, X₂ 706, . . . , Xₜ₋₁ 708) as input. The environmental data (X₁ 704, X₂ 706, . . . , Xₜ₋₁ 708) can be encoded by a LSTM encoder 710 and can generate corresponding keys (h) in block 712, which can include h₁ 714, h₂ 716, . . . , hₜ₋₁ 718. The environment data at timestamp t (Xₜ) 730 can pass through a LSTM encoder 732, be used as a query 734, and the query can be matched to the keys (hₜ) 736 in a temporal attention module 720 to generate corresponding attention weights (α) 722, which can include α₁ 724, α₂ 726, . . . aₜ₋₁ 728, in accordance with aspects of the present invention.

In some embodiments, in the residual generation stage 703, the environment attention weights 722 can be cross applied by executing cross attention in block 738 to system data 742 (Y) (e.g., real-time or historical system data), which can include y₁ 744, y₂ 746, . . . , yₜ₋₁ 748. The weights for X₁ 704, X₂ 706, . . . , Xₜ₋₁ 708 can be utilized to multiply y₁ 744, y₂ 746, . . . , yₜ₋₁ 748, and the attention weighted system data (y₁ 744, y₂ 746, . . . , yₜ₋₁ 748) can be utilized to predict the value at time t (yₜ) using a predictor module loss function (yₜ-yₜ′)² 750 to generate a predicted value (yₜ′) 752. The differences between yₜ and yₜ′ can be output as the residual_A in block 754, in accordance with aspects of the present invention. In a model training stage, the parameters of an LSTM encoder, temporal attention module and prediction module can be adjusted to minimize the loss function of (yₜ yₜ′)² 750, where yₜ is the real value and yₜ′ can represent the predicted value (yₜ′) 752. In the online testing stage, the difference of (yₜ-yₜ′) can be output as the residual_A score 754, and utilized for further processing and/or analysis, in accordance with aspects of the present invention.

Referring now to FIG. 8, with reference to FIGS. 6, 7, and 11, a diagram showing a system 800 for anomaly detection based on an analysis of a plurality of different types of data from vehicle sensors for autonomous, semi-autonomous, and/or notification-assisted operation of a vehicle, is illustratively depicted in accordance with embodiments of the present invention.

In some embodiments, an anomaly detector (e.g., LTSM) can be utilized in a similar manner as in the residual generation stage (shown in block 703 of FIG. 7) of cross attention based detection, but in this embodiment, the anomaly detector may not include a cross attention stage. System data (Y) 802 (y₁ 804, y₂ 806, . . . , yₜ₋₁ 808) (e.g., real-time or historical) can be collected and/or received as input, and can be utilized by a predictor module loss function (yₜ-yₜ′) 810 to predict a value at time t (e.g., yₜ″) 812, where the differences between yₜ and yₜ′ can be output as the residual_V (Residual_V=|y-y″|) in block 814. In a model training stage, the parameters of the prediction module 810 can be adjusted to minimize the loss function of (yₜyₜ″)², where yₜ represents the real value and yₜ″ represents the predicted value. In an online testing stage, the difference of (yₜ-yₜ″)² can be output as the residual_V score 814, in accordance with aspects of the present invention.

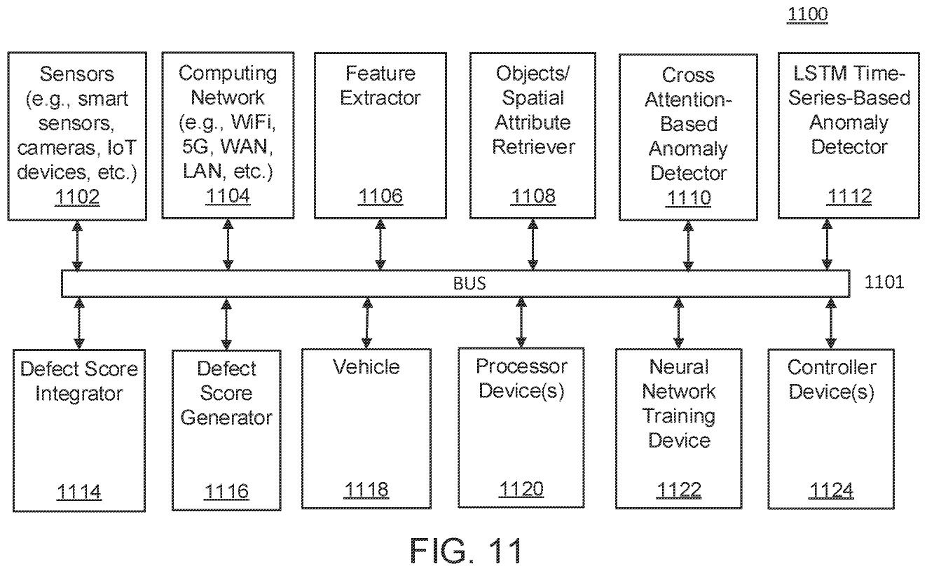

In some embodiments, a score integrator (shown in block 626 of FIG. 6 and block 1114 of FIG. 11) can compare the residual scores from block 754 of FIG. 7 and block 814 of FIG. 8, and analyze them to determine final defect scores. The final defect scores 628 can be computed as follows:
defect_score=max (0, residual_A-residual_V),
   in accordance with aspects of the present invention. If the score residual_A is smaller than residual_V, it can indicate that the changes of system data are adaptive to the environment changes, and thus, the system can be determined to have conducted appropriate re-actions to the environment changes, resulting in no finding of a defect. If the score residual_A is larger than residual_V, it can indicate that changes of system data (e.g., driving actions) have been determined to be not appropriate with regard to the environmental changes (e.g., obstacle in road, etc.), or even an opposite action to deemed appropriate actions to the environment changes, in can indicate that the system executed inappropriate re-actions to the environment changes, resulting in a finding of a defect, which can be reported to the user, in accordance with aspects of the present invention.

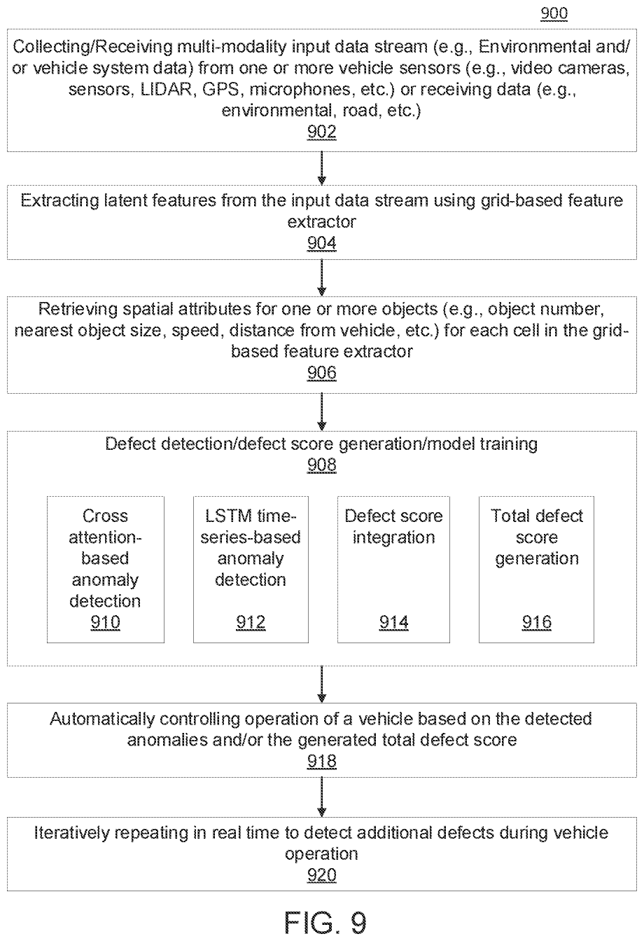

Referring now to FIG. 9, a block/flow diagram showing a method 900 for cross-attention based defect detection based on an analysis of a plurality of different types of data from vehicle sensors for autonomous, semi-autonomous, and/or notification-assisted operation of a vehicle, is illustratively depicted in accordance with embodiments of the present invention.

In various embodiments, in block 902, a multi-modality input data stream (e.g., Environmental and/or vehicle system data) can be collected from one or more vehicle sensors (e.g., video cameras, sensors, LIDAR, GPS, microphones, etc.) and/or can be received as input data (e.g., environmental, road, etc.) by any appropriate transmission/receiving means, in accordance with aspects of the present invention. In block 904, latent features can be extracted from one or more input data streams using a grid-based feature extractor.

In block 906, spatial attributes (e.g., object number, nearest object size, speed, distance from vehicle, etc.) can be retrieved for one or more objects for each cell in a grid-based feature extractor. In block 908, anomaly and/or defect detection, defect score generation, and/or model training can be performed, and can include cross attention-based anomaly detection in block 910, LSTM time-series-based anomaly detection in block 912, defect score integration in block 914, and/or total defect score generation in block 916, in accordance with aspects of the present invention.

In some embodiments, in block 918, any of a plurality of operations (e.g., accelerating, turning, braking, adjusting lighting or other vehicle features, etc.) of a vehicle can be automatically controlled based on the detected anomalies and/or the generated total defect score. The collecting in block 902, extracting in block 904, retrieving in block 906, defect detection/defect score generation/model training in block 908 (including blocks 910, 912, 914, and 916), and the controlling operation of a vehicle in block 918, can be iteratively repeated before, during, and/or after operation of a vehicle to detect and/or report additional defects, and to adjust the automatically controlling of the vehicle in block 918 to account for any newly detected defects and/or anomalies, in accordance with aspects of the present invention.

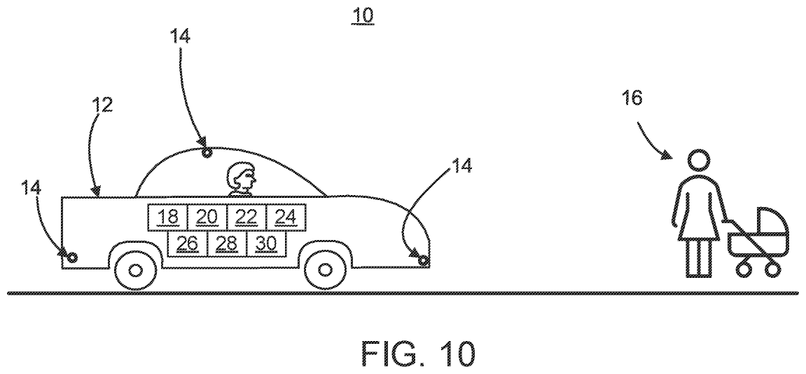

Referring now to FIG. 10, a diagram showing an exemplary system 1000 including an exemplary vehicle utilizing cross-attention based defect detection based on an analysis of a plurality of different types of data from vehicle sensors for autonomous, semi-autonomous, and/or notification-assisted operation of a vehicle, is illustratively depicted in accordance with an embodiment of the present invention.

The system 1000 can include an autonomous vehicle 12. In one embodiment, the autonomous vehicle 12 can be an automobile. In other embodiments, the autonomous vehicle 12 can include a boat, plane, helicopter, truck, boat, etc. The autonomous vehicle 12 can include a propulsion system 18. For an airborne embodiment, the propulsion system 18 can include propellers or other engines for flying the autonomous vehicle 12. In another embodiment, the propulsion system 18 can include wheels or tracks. In another embodiment, the propulsion system 18 can include a jet engine or hover technology. The propulsion system 18 can include one or more motors, which can include an internal combustion engine, electric motor, etc.

The autonomous vehicle 12 can include a power source 20. The power source 20 can include or employ one or more batteries, liquid fuel (e.g., gasoline, alcohol, diesel, etc.) or other energy sources. In another embodiment, the power source 20 can include one or more solar cells or one or more fuel cells. In another embodiment, the power source 20 can include combustive gas (e.g., hydrogen).

The autonomous vehicle 12 can be equipped with computing functions and controls. The autonomous vehicle 12 can include a processor 22. The autonomous vehicle 12 can include a transceiver 24. In one embodiment, the transceiver 24 can be coupled to a global position system (GPS) to generate and alert of a position of the autonomous vehicle 12 relative to other vehicles in a common coordinate system. The transceiver 24 can be equipped to communicate with a cellular network system. In this way, the autonomous vehicle's position can be computed based on triangulation between cell towers base upon signal strength or the like. The transceiver 24 can include a WIFI or equivalent radio system. The processor 22, transceiver 24, and location information can be utilized in a guidance control system 26 for the autonomous vehicle 12.

The autonomous vehicle 12 can include memory storage 28. The memory storage 28 can include solid state or soft storage and work in conjunction with other systems on the autonomous vehicle 12 to record data, run algorithms or programs, control the vehicle, etc. The memory storage 28 can include a Read Only Memory (ROM), random access memory (RAM), or any other type of memory useful for the present applications.

The autonomous vehicle 12 can include one or more sensors 14 (e.g., cameras, proximity sensors, LIDAR, radar, GPS, etc.) for collecting data of a plurality of different data types before, during, and/or after utilization of the autonomous vehicle 12. The one or more sensors 14 can view the area surrounding the autonomous vehicle 12 to input sensor data into an Autonomic Driving Assistant System (ADAS) data processing and analysis engine 30 and the guidance control system 26 of the autonomous vehicle 12. The one or more sensors 14 can detect objects around the autonomous vehicle 12, e.g., other vehicles, building, light poles, pedestrians 16, trees, etc., and/or internal vehicle functions and/or status of vehicle components. The data obtained by the one or more sensors 14 can be processed by the ADAS engine 30 of the autonomous vehicle 12 and can be utilized by the guidance control system 26 to, for example, adjust the propulsion system 18 of the autonomous vehicle 12 to avoid objects around the autonomous vehicle 12, in accordance with various aspects of the present invention.

Referring now to FIG. 11, a diagram showing a system 1100 for cross-attention based defect detection based on an analysis of a plurality of different types of data from vehicle sensors for autonomous, semi-autonomous, and/or notification-assisted operation of a vehicle, is illustratively depicted in accordance with embodiments of the present invention.

In some embodiments, one or more sensors 1102 (e.g., LIDAR, GPS, smart sensors, cameras, IoT devices, etc.) can collect data, and data streams from the sensors 1102 can be transmitted over a computing network 1104 (e.g., WiFi, wireless, 4G, 5G, CAN bus, LAN, WAN, wired, etc.), and can be analyzed using one or more processor devices 1120, which can be deployed on a vehicle 1118 or remotely from a vehicle 1118, in accordance with aspects of the present invention. A feature extractor 1106 can extract features from data collected and/or received from the sensors 1102. The features can be further processed by an objects/spatial attribute retriever device 1108, and anomalies and/or defects can be identified using a cross attention-based anomaly detector 1110 and/or a LSTM time-series-based anomaly detector 1112.

In various embodiments, anomalies detected by the cross attention-based anomaly detector 1110 and/or the LSTM time-series-based anomaly detector 1112 can be output to a defect score integrator 1114, which can combine the data received from the detectors 1110 and/or 1112, and utilized as input to a defect score generator 1116 to generate one or more defect scores, in accordance with aspects of the present invention. A neural network training device 1122 can be utilized to further increase accuracy and speed of detection of anomalies and/or defects by, for example, iteratively training a neural network using new data retrieved by the one or more sensors 1102.

In various embodiments, one or more controller devices 1124 can be utilized to adjust any of a plurality of vehicle operations (e.g., accelerate, brake, lighting, etc.) responsive to a determination of anomalies and/or defects with defect scores above a user-selectable predetermined defect score threshold and/or particular events identified during operation of a vehicle to improve autonomous navigation of the vehicle, in accordance with aspects of the present invention.

In the embodiment shown in FIG. 11, the elements thereof are interconnected by a bus 1101. However, in other embodiments, other types of connections can also be used. Moreover, in an embodiment, at least one of the elements of system 1100 is processor-based and/or a logic circuit and can include one or more processor devices 1120. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 1100 are readily determined by one of ordinary skill in the art, given the teachings of the present principles provided herein, while maintaining the spirit of the present principles.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for defect detection for vehicle operations, comprising:
collecting a multiple modality input data stream from a plurality of different types of vehicle sensors;
extracting one or more features from the input data stream using a grid-based feature extractor;
retrieving spatial attributes of objects positioned in any of a plurality of cells of the grid-based feature extractor;
detecting one or more anomalies based on residual scores generated by each of cross attention-based anomaly detection and time-series-based anomaly detection;
identifying one or more defects based on a generated overall defect score determined by integrating the residual scores for the cross attention-based anomaly detection and the time-series based anomaly detection being above a predetermined defect score threshold; and
controlling operation of the vehicle based on the one or more defects identified.

2. The method as recited in claim 1, wherein the cross attention-based anomaly detection utilizes the spatial attributes of the objects and vehicle system data, and the time-series-based anomaly detection utilizes vehicle system data during the detecting.

3. The method as recited in claim 1, wherein the objects are environmental objects representing one or more hazardous conditions.

4. The method as recited in claim 1, wherein the grid-based feature extractor includes nine (9) of the cells, with a vehicle being positioned in a center cell of the grid-based feature extractor.

5. The method as recited in claim 1, wherein additional defects are continuously detected in real-time during operation of the vehicle by iteratively repeating the collecting, the extracting, the retrieving, the detecting, and the identifying during the operation of the vehicle.

6. The method as recited in claim 1, wherein the cross attention-based anomaly detection further comprises:
generating environmental attention weights in an attention computation stage by encoding received environmental data and generating one or more keys, with the keys being matched with a query in a temporal attention stage;
cross-applying the environmental attention weights to historical system data of the vehicle to generate a prediction of a value at a next timestep; and
training a model by adjusting one or more parameters for the prediction to minimize a loss function between a real value and the predicted value.

7. The method as recited in claim 1, wherein the overall defect score is determined as follows:
Defect_Score=max (0, Residual_A—Residual_V),
where Residual_A represents output of the cross attention-based anomaly detection, and Residual_V represents output of the time-series-based anomaly detection.

8. A system for defect detection for vehicle operations, comprising:
one or more processors operatively coupled to a non-transitory computer-readable storage medium, the processors being configured for:
collecting a multiple modality input data stream from a plurality of different types of vehicle sensors;
extracting one or more features from the input data stream using a grid-based feature extractor;
retrieving spatial attributes of objects positioned in any of a plurality of cells of the grid-based feature extractor;
detecting one or more anomalies based on residual scores generated by each of cross attention-based anomaly detection and time-series-based anomaly detection;
identifying one or more defects based on a generated overall defect score determined by integrating the residual scores for the cross attention-based anomaly detection and the time-series based anomaly detection being above a predetermined defect score threshold; and
controlling operation of the vehicle based on the one or more defects identified.

9. The system as recited in claim 8, wherein the cross attention-based anomaly detection utilizes the spatial attributes of the objects and vehicle system data, and the time-series-based anomaly detection utilizes vehicle system data during the detecting.

10. The system as recited in claim 8, wherein the objects are environmental objects representing one or more hazardous conditions.

11. The system as recited in claim 8, wherein the grid-based feature extractor includes nine (9) of the cells, with a vehicle being positioned in a center cell of the grid-based feature extractor.

12. The system as recited in claim 8, wherein additional defects are continuously detected in real-time during operation of the vehicle by iteratively repeating the collecting, the extracting, the retrieving, the detecting, and the identifying during the operation of the vehicle.

13. The system as recited in claim 8, wherein the cross attention-based anomaly detection further comprises:
generating environmental attention weights in an attention computation stage by encoding received environmental data and generating one or more keys, with the keys being matched with a query in a temporal attention stage;
cross-applying the environmental attention weights to historical system data of the vehicle to generate a prediction of a value at a next timestep; and
training a model by adjusting one or more parameters for the prediction to minimize a loss function between a real value and the predicted value.

14. The system as recited in claim 8, wherein the overall defect score is determined as follows:
Defect_Score=max (0, Residual_A—Residual_V),
where Residual_A represents output of the cross attention-based anomaly detection, and Residual_V represents output of the time-series-based anomaly detection.

15. A non-transitory computer readable storage medium comprising a computer readable program operatively coupled to a processor device for defect detection for vehicle operations, wherein the computer readable program when executed on a computer causes the computer to perform the steps of:
collecting a multiple modality input data stream from a plurality of different types of vehicle sensors;
extracting one or more features from the input data stream using a grid-based feature extractor;
retrieving spatial attributes of objects positioned in any of a plurality of cells of the grid-based feature extractor;
detecting one or more anomalies based on residual scores generated by each of cross attention-based anomaly detection and time-series-based anomaly detection;
identifying one or more defects based on a generated overall defect score determined by integrating the residual scores for the cross attention-based anomaly detection and the time-series based anomaly detection being above a predetermined defect score threshold; and
controlling operation of the vehicle based on the one or more defects identified.

16. The non-transitory computer readable storage medium as recited in claim 15, wherein the cross attention-based anomaly detection utilizes the spatial attributes of the objects and vehicle system data, and the time-series-based anomaly detection utilizes vehicle system data during the detecting.

17. The non-transitory computer readable storage medium as recited in claim 15, wherein the grid-based feature extractor includes nine (9) of the cells, with a vehicle being positioned in a center cell of the grid-based feature extractor.

18. The non-transitory computer readable storage medium as recited in claim 15, wherein additional defects are continuously detected in real-time during operation of the vehicle by iteratively repeating the collecting, the extracting, the retrieving, the detecting, and the identifying during operation of the vehicle.

19. The non-transitory computer readable storage medium as recited in claim 15, wherein the cross attention-based anomaly detection further comprises:
generating environmental attention weights in an attention computation stage by encoding received environmental data and generating one or more keys, with the keys being matched with a query in a temporal attention stage;
cross-applying the environmental attention weights to historical system data of the vehicle to generate a prediction of a value at a next timestep; and
training a model by adjusting one or more parameters for the prediction to minimize a loss function between a real value and the predicted value.

20. The non-transitory computer readable storage medium as recited in claim 15, wherein the overall defect score is determined as follows:
Defect_Score=max (0, Residual_A—Residual_V),
where Residual_A represents output of the cross attention-based anomaly detection, and Residual_V represents output of the time-series-based anomaly detection.
